(19) United States
(12) Patent Application Publication
(10) Pub. No.: US 2026/0119706 A1
(43) Pub. Date: Apr. 30, 2026

(54) Selective and Transparent User Data Encryption in Network Devices

(71) Applicant: Arista Networks, Inc., Santa Clara, CA (US)

(72) Inventors: Baptiste Elie Franck Covolato, Vancouver (CA); Robert Eamon Hrusecky, Austin, TX (US); Julien Andre Alexis Gomes, Langley (CA); Ethan B. Rahn, Agoura Hills, CA (US); Ilia Andreevich Lebedev, Cambridge, MA (US)

(21) Appl. No.: 19/072,282

(22) Filed: Mar. 6, 2025

Related U.S. Application Data
(60) Provisional application No. 63/712,345, filed on Oct. 25, 2024.

(51) Int. Cl. G06F 21/62; G06F 21/60; G06F 21/78

(52) U.S. Cl. CPC G06F 21/6245; G06F 21/602; G06F 21/78

(57) ABSTRACT

Techniques for encrypting user data on the persistent storage of a network device are provided. In certain embodiments, these techniques can selectively encrypt user data only (and thus leave operating system (OS) and boot data on the persistent storage unencrypted), which facilitates recovery of the network device in case of decryption failure. In further embodiments, the techniques can perform the encryption operations transparently (i.e., without user interaction or knowledge), which eliminates the possibility of data leakage due to user error.

### CROSS-REFERENCES TO RELATED APPLICATIONS

Pursuant to 35 U.S.C. § 119 (e), the present application is entitled to and claims the benefit of the filing date of U.S. Provisional Application No. 63/712,345, filed Oct. 25, 2024. The entire contents of this provisional application are incorporated by reference herein for all purposes.

### BACKGROUND

Modern network devices typically include persistent (i.e., non-volatile) storage for holding both operating system (OS)/boot data and user data. OS/boot data refers to data required by a network device for booting into its OS (and entering Zero Touch Provisioning (ZTP) mode if appropriate), such as OS image and bootloader files. User data refers to all other data that is not OS/boot data (and is usually associated with or provided by device users), such as startup configuration files, user access credentials, and so on.

For security and privacy reasons, it is becoming increasingly important for network devices to support the encryption of user data. However, traditional data encryption solutions suffer from various issues that limit their usefulness for this purpose, particularly in large network deployments.

### BRIEF DESCRIPTION OF THE DRAWINGS

With respect to the discussion to follow and in particular to the drawings, it is stressed that the particulars shown represent examples for purposes of illustrative discussion and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 depicts an example network device in accordance with certain embodiments of the present disclosure.

FIG. 2 depicts another example network device in accordance with certain embodiments of the present disclosure.

FIG. 3 depicts the architecture of a user data encryption framework in accordance with certain embodiments of the present disclosure.

FIG. 4 depicts a merger layer setup workflow in accordance with certain embodiments of the present disclosure.

FIG. 5 depicts an orchestrator workflow in accordance with certain embodiments of the present disclosure.

### DETAILED DESCRIPTION

In the following description, for purposes of explanation, numerous examples and details are set forth in order to provide an understanding of embodiments of the present disclosure. Particular embodiments as expressed in the claims may include some or all of the features in these examples, alone or in combination with other features described below, and may further include modifications and equivalents of the features and concepts described herein.

Embodiments of the present disclosure are directed to techniques for encrypting user data on the persistent storage of a network device like a switch or router. In certain embodiments, these techniques can selectively encrypt user data only (and thus leave OS/boot data on the persistent storage unencrypted), which facilitates recovery of the network device in case of decryption failure. In further embodiments, the techniques can perform the encryption operations transparently (i.e., without user interaction or knowledge), which eliminates the possibility of data leakage due to user error.

### 1. Example Network Device

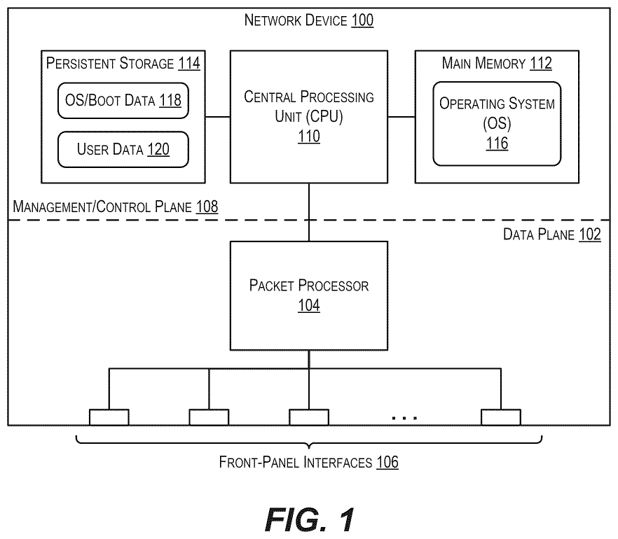

FIG. 1 is a simplified block diagram of a network device (e.g., switch or router) 100 in which the techniques of the present disclosure may be implemented. As shown, network device 100 comprises a data plane 102 including a packet processor 104 and a set of front-panel interfaces (i.e., ports) 106. Packet processor is typically an integrated circuit, such as an application-specific integrated circuit (ASIC) or a field-programmable gate array (FPGA), that is responsible for performing line-speed processing of network traffic (i.e., packets) that pass through network device 100 via front-panel interfaces 106. This line-speed processing can include, for example, Layer 2 (L2) forwarding (i.e., bridging) and Layer 3 (L3) forwarding (i.e., routing) of network packets.

Network device 100 also comprises a management/control plane 108 including a central processing unit (CPU) 110, a main memory (e.g., random-access memory (RAM)) 112, and a persistent storage 114. CPU 110 is a general-purpose processor that is responsible for managing the configuration/operation of network device 100 and controlling the device's understanding of the network in which it resides. CPU 110 carries out these functions under the direction of an operating system (OS) 116 that runs on CPU 110 from main memory 112.

Persistent storage 114 is a non-volatile storage device (e.g., an embedded MultiMediaCard (eMMC), a Non-Volatile memory Express (NVMe) solid-state disk (SSD), a Serial Advanced Technology Attachment (SATA) SSD, etc.) and is configured to hold both OS/boot data 118 and user data 120 used by network device 100. As mentioned previously, OS/boot data 118 is data required by network device 100 for booting into OS 116 and entering a ZTP mode if appropriate (which is a mode in which the device can configure itself for initial/default operation without manual intervention). Examples of OS/boot data include the image file for OS 116, bootloader configuration files, bootloader upgrade files, and bootloader and Basic Input/Output System (BIOS) log files. User data 120 comprises all other types of data held on persistent storage 114 (and is typically associated with or input by the users of network device 100). Examples of user data include OS configuration files (including startup configuration), Secure Shell (SSH) keys and other security metadata used by OS 116, OS extension files, OS log files, user-defined files/scripts/logs, and backup OS image files.

### 2. Problem Statement and Solution Overview

Because user data 120 held in persistent storage 114 can include confidential and/or sensitive information, there is a need to secure this user data via data encryption. One traditional data encryption approach, known as full disk encryption or FDE, involves encrypting the entire contents of persistent storage 114, including both user data 120 and OS/boot data 118. However, this approach involves modifications to and coordination with network device 100's BIOS and bootloader, which means that configuring certain aspects of FDE requires physical access to the device (for interacting with the BIOS or bootloader).

Further, because FDE encrypts OS/boot data 118, if decryption fails for any reason, network device 100 cannot recover by automatically booting into ZTP mode. Instead, a user must manually recover the device via direct physical (e.g., console) access. These issues are undesirable for network device customers and are particularly problematic in large-scale network deployments that may include hundreds or thousands of network devices.

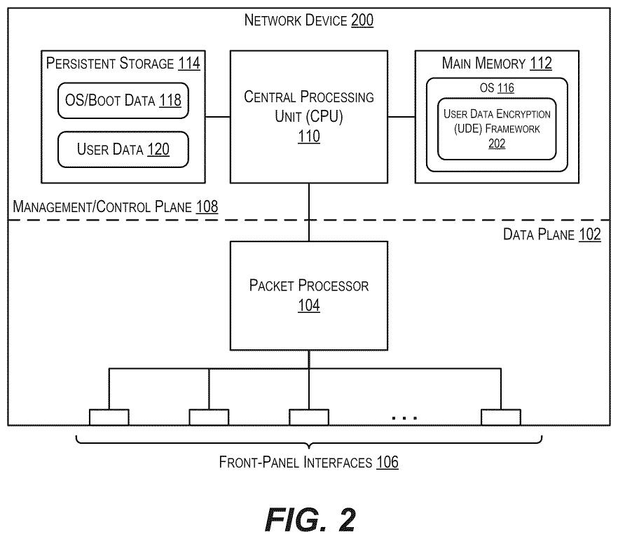

To address the foregoing and other related problems, FIG. 2 depicts an enhanced version 200 of network device 100 that implements, within OS 116, a novel user data encryption framework (UDE framework) 202 according to certain embodiments. At a high level, UDE framework 202 comprises a set of filesystem abstraction layers that enable network device 200 to operate in a user data encryption mode (UDE mode). When UDE mode is configured (i.e., enabled), UDE framework 202 can selectively encrypt user data 120 only on persistent storage 114, such that OS/boot data 118 (which is needed for the boot process and ZTP mode) is left unencrypted. In addition, UDE framework 202 can perform this encryption transparently, or in other words in a manner that does not require the users of network device 200 to specify which files should be encrypted or know where such encrypted files should be placed. Rather, the device users can simply create/update files on network device 200 without regard to this feature, and UDE framework 202 can automatically identify which files constitute OS/boot data or user data, encrypt (or refrain from encrypting) the files accordingly, and place the encrypted and unencrypted files at appropriate locations on persistent storage 114.

With this general approach and framework, a number of benefits are realized. First, because UDE framework 202 is implemented entirely within OS 116, it can be configured and managed remotely over a management network (e.g., via an SSH session), without requiring direct physical access to network device 200. Second, because OS/boot data 118 remains unencrypted, no manual intervention is needed in a scenario where decryption fails; instead, network device 200 can automatically boot into ZTP mode using the unencrypted OS image and bootloader files, thereby facilitating remote recovery over the management network. Third, because the user data encryption performed by UDE framework 202 is transparent to device users, there is no possibility of data leakage due to user error. Stated another way, device users cannot inadvertently place certain user files in an unencrypted directory, forget to encrypt certain user files, or make other mistakes that cause sensitive user data to be exposed in unencrypted form, because UDE framework 202 does not rely on user input/involvement for identifying what files should be encrypted and where they should be stored; the framework handles all of this in an automated fashion.

It should be appreciated that FIGS. 1 and 2 and the foregoing high-level solution description are illustrative and not intended to limit embodiments of the present disclosure. For example, although FIGS. 1 and 2 depict a particular arrangement of components in network device 100/200, other arrangements are possible (e.g., the functionality attributed to a particular component may be split into multiple components, components may be combined, etc.). One of ordinary skill in the art will recognize other similar modifications, variations, and alternatives.

### 3. Example Framework Implementation

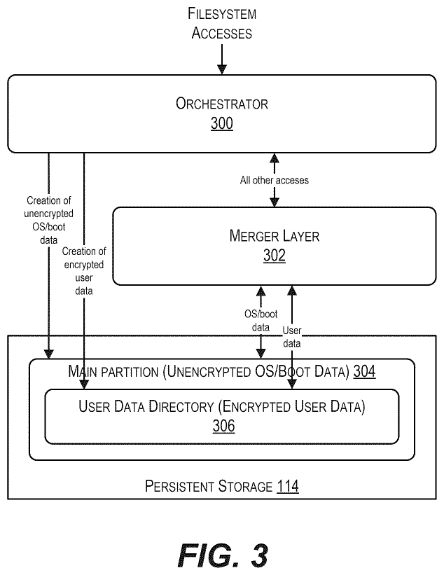

The remaining sections of this disclosure describe an example implementation of UDE framework 202 along with various related considerations and aspects. For example, FIG. 3 depicts an architecture of UDE framework 202 according to this example implementation that includes a filesystem orchestration layer (i.e., orchestrator) 300 and a filesystem merger layer 302. Filesystem layers 300 and 302, which are described in turn below, interact with persistent storage 114 to selectively and transparently encrypt user data 120 when UDE mode is turned on. In alternative embodiments, the functionality of filesystem layers 300 and 302 can be combined into a single layer.

As shown in FIG. 3, the design of UDE framework 202 causes OS/boot data 118 to be stored in unencrypted form within an unencrypted main partition 304 on persistent storage 114 and causes user data 102 to be stored in encrypted form within an encrypted user data directory 306 of partition 304. User data directory 306 is assumed to be encrypted using an OS-level encryption utility that can encrypt individual files and directories, such as “fscrypt.” Further, all filesystem accesses to persistent storage 114 (whether system-driven or user-driven) are assumed to be made through a singular mount point (e.g., “/mnt/flash”), referred to as the storage mount point, to which orchestrator 300 is mounted.

### 3.1 Merger Layer

Merger layer 302 is designed to provide a unified (i.e., merged) view of unencrypted main partition 304 (which holds unencrypted OS/boot data) and encrypted user data directory 306 (which holds encrypted user data) to orchestrator 300. In one set of embodiments, merger layer 302 can be implemented using the existing Linux union filesystem “mergerfs.” In other embodiments, other types of union filesystems can be employed for this purpose, or the functionality of merger layer 302 can be incorporated into orchestrator 300. One advantage provided by mergerfs is that the lower filesystem layers being merged (i.e., main partition 304 and user data directory 306) remain fully functional and independent filesystems that can be directly modified. This property is useful because, as described in section 3.2 below, orchestrator 300 directly accesses main partition 304 and user data directory 306 in order to create new filesystem objects (e.g., files and directories).

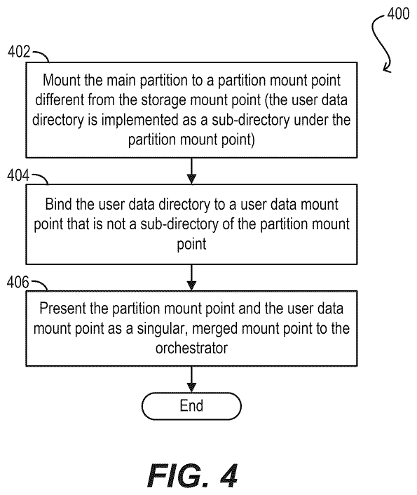

FIG. 4 depicts a workflow 400 for configuring/setting up merger layer 302 according to certain embodiments. Workflow 400 can be executed by a user of network device 200 or an automated process/agent of UDE framework 202.

Starting with step 402, main partition 304 can be mounted to a partition mount point that is different from the storage mount point (e.g., “/mnt/.eos/flash”). User data directory 306 can be implemented as a sub-directory under the partition mount point, such as “/mnt/.eos/flash/user-data”.

At step 404, user data directory 306 can be bound to a user data mount point that is not a sub-directory of the partition mount point (e.g., “/mnt/.eos/user-data”). This ensures that file moves between main partition 304 and user data directory 306 are carried out via a copy operation and a remove operation (rather than a move operation), which will cause files that are moved out of user data directory 306 to main partition 304 to be automatically decrypted and files that are moved out of main partition 304 to user data directory 306 to be automatically encrypted (which is the desired behavior).

Finally, at step 406, merger layer 302 can be configured to present the partition mount point and the user data mount point as a singular mount point (e.g., “/mnt/.eos/merger-data”), referred to as the merged mount point, to orchestrator 300.

### 3.2 Orchestrator

Orchestrator 300 is designed to intercept filesystem accesses directed to persistent storage 114 that originate from device users (e.g., via a command line interface (CLI)) or other parts of OS 116 (e.g., applications, OS agents, etc.) and, if a particular filesystem access pertains to the creation of a file or directory, creates the file/directory in encrypted or unencrypted form (as appropriate) in user data directory 306 or main partition 304 respectively.

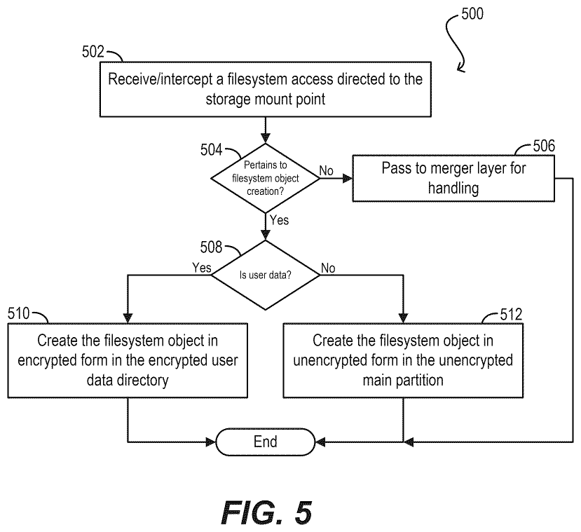

FIG. 5 depicts a workflow 500 that may be executed by orchestrator 300 for carrying out this process according to certain embodiments. Workflow 500 assumes that UDE mode is configured/enabled.

Starting with step 502, orchestrator 300 can receive/intercept a filesystem access directed to persistent storage 114 (i.e., the storage mount point). As noted above, orchestrator 300 is mounted to this storage mount point, which allows orchestrator 300 to intercept all incoming filesystem accesses.

At step 504, orchestrator 300 can determine whether the filesystem access pertains to the creation of a filesystem object (e.g., a file, directory, etc.) on persistent storage 114. If the answer is no, orchestrator 300 can simply pass the filesystem access through to merger layer 302 for handling (step 506).

However, if the answer is yes, orchestrator 300 can further determine whether the filesystem object being created is user data (step 508). In certain embodiments, orchestrator 300 can perform this check by accessing a predefined list of filesystem objects that are known to represent OS/boot data, referred to as the exception list, and determining whether the filesystem object name specified in the creation operation is present in the exception list (which indicates that it is not user data) or not present in the exception list (which indicates that it is user data).

If the filesystem access pertains to the creation of user data, orchestrator 300 can create the filesystem object in user data directory 306 (step 510), which will cause the created object to be automatically encrypted via the OS-level file encryption utility mentioned previously.

On the other hand, if the filesystem access does not pertain to the creation of user data (i.e., it pertains to the creation of OS/boot data), orchestrator 300 can create the filesystem object in main partition 304 (step 512), which will cause the created object to remain unencrypted.

In some embodiments, the exception list may specifically omit OS image files, even though such files are needed by network device 200 in order to boot into OS 116. In these embodiments, other components of OS 116 may be made encryption-aware and may selectively place such OS image files in main partition 304 directly. In addition, an OS plugin may prevent a device user from reloading OS 116 if the OS image file specified in the boot configuration is not present in main partition 304.

Further, the exception list may specifically omit OS extension and startup configuration files. This is because (1) OS extension files are not needed for the device to operate in ZTP mode, and (2) encryption of the startup configuration file ensures that network device 200 enters ZTP mode in the case of decryption failure (due to the startup configuration file being unable to be found).

Yet further, in some embodiments orchestrator 300 may mask certain directories that hold encryption metadata/data and are present in the merged and/or partition mount points (e.g., user-data and .fscrypt directories) from being accessed through the storage mount point. This prevents device users from mistakenly accessing the encryption metadata/data, which could result in unintended consequences and cause various errors or odd behaviors. For example, tampering with the encryption keys could result in the loss of user data.

### 3.3 Configuration and Setup

As mentioned previously, UDE mode can be selectively configured (i.e., enabled) and disabled by the users of network device 200. In certain embodiments, this configuration can be carried out via two methods: a hitless method that is performed in the background while OS 116 continues operating as normal and a hit-full method that requires a reboot of network device 200.

### 3.3.1 Encryption Setup

Regardless of the configuration method employed (hitless or hit-full), encryption of user data directory 204 should be turned on at the time UDE mode is configured in order to ensure that all files and directories created in user data directory 204 are automatically encrypted.

In embodiments where encryption is implemented via fscrypt, this can be achieved by running the “fscrypt setup” command on the storage mount point and configuring a protector and an associated policy on user data directory 306. A protector represents a secret (i.e., encryption password) that protects data confidentiality, while a policy represents the actual kernel keys used to perform the low level encryption.

In certain embodiments, the raw key for the protector can be stored in the non-volatile RAM (NVRAM) of a Trusted Platform Module (TPM) of network device 200. This raw key protects the kernel keys, which are AES 256 bit keys generated by fscrypt using the randomness of the system. By storing the raw key in the TPM's NVRAM, it is possible for users of network device 200 to define security policies that control the conditions under which the TPM will allow software (e.g., OS 116) to read the key. For example, one such policy could make the raw key readable only if a Platform Configuration Register (PCR) in the TPM matches an expected value corresponding to an expected version of the software. This means that if network device 200 is running any other software version than what is described in the policy (e.g., malicious software), the PCR will not match the expected value and thus the TPM will not allow reading of the key.

In a particular embodiment, “eos-user-data-<NUMBER>” (or some other number-based format) can be used as the name for the protector. The reason for relying on numbers rather than a unique protector name pertains to fscrypt's lack of support for rotating a protector's raw key. The procedure to achieve rotation is to create a new protector, add it to the policy by authorizing it with the old protector, and then remove the old protector. Except for rotation, OS 116 should always maintain only one “eos-user-data-<NUMBER>” protector that matches the key stored in the TPM. While rotation is ongoing, there will temporarily be two different “eos-user-data-<NUMBER>” protectors that can unlock user data directory 306.

### 3.3.2 Hitless Configuration

One complication with hitless configuration of UDE mode is that the storage mount point generally cannot be unmounted while OS 116 is running. To address this, in certain embodiments orchestrator 300 can run as the storage mount point at all times. When UDE mode is not configured (i.e., disabled), orchestrator 300 can operate in a passthrough mode that involves passing all filesystem accesses to the storage mount point through to the partition mount point. When UDE mode is configured (and the encryption setup noted above is completed), orchestrator 300 can switch over to encrypting user data as described in section 3.2 above.

It should be noted that, in some embodiments, configuration of UDE mode only causes newly created files and directories to be encrypted; it doesn't deal with any of the files in main partition 304 that existed prior to turning on the mode. Accordingly, in these embodiments OS 116 should execute a one-time move of all unencrypted files from main partition 304 to user data directory 306 using the same exception list that is employed by orchestrator 300. There are a number of complexities with this moving of data that are described in section 3.4 below.

### 3.3.3 Hit-Full Configuration

With hit-full configuration, orchestrator 300 only needs to run when UDE mode is enabled. When UDE mode is disabled, the storage mount point can be bound to the partition mount point, thereby causing all filesystem accesses directed to the storage mount point to go to main partition 304.

At the time a device user turns on UDE mode via the hit-full approach, OS 116 can carry out the encryption setup noted above and reboot the system. During the next boot, OS 116 should perform a one-time move of all unencrypted user data files from main partition 304 to user data directory 306.

### 3.3.4 Configuration after Decryption Failure

If decryption fails and network device 200 boots into ZTP mode, it is possible for a user to configure UDE mode at that point. In this scenario, OS 116 can first erase the existing/undecrypted user data directory 306 and associated key in the TPM before proceeding with the normal hitless or hit-full configuration process.

### 3.4 Moving Data Between the Unencrypted and Encrypted Areas

As noted previously, there are a number of challenges with moving data between unencrypted main partition 304 and encrypted user data directory 306, which is required by both hitless and hit-full configuration.

The first challenge relates to the possibility of running out of storage space on persistent storage 114. The move operation is performed as a copy+remove so that the data is encrypted or decrypted depending on the direction of the move. Contrarily to a true move, a copy operation necessitates enough space to be available before the copy can be initiated. To address this, the various workflows/functionalities requiring a move operation can perform appropriate checks to ensure enough space is available at the destination. In the case of moving an entire directory, the files in the directory can be copied and deleted one at a time, to minimize the extra space needed for the operation.

The second challenge relates to the fact that while the data is being moved internally, data continuity and coherence must be maintained from the user perspective. For example, enabling UDE mode may require the user file “/mnt/.eos/flash/startup-config” to be moved to “/mnt/.eos/user-data/startup-config,” but as far as the device users are concerned this file should not appear to move anywhere (i.e., it should remain in “/mnt/flash/startup-config”).

To address this second challenge, orchestrator 300 can be configured to handle the move (copy+remove) operation. With this approach, orchestrator 300 can track the progress of the move operation and can serve user-initiated reads and writes directed to the storage mount point from the appropriate underlying storage area (i.e., main partition 304 or user data directory 306), thereby maintaining data consistency from the user perspective. There are three cases to consider:
1. A read or write is received to a section of a file that has already been moved. In this case, the read/write can be served from the destination file.
2. A read or write is received to a section of a file that is in the process of being copied by orchestrator 300. In this situation, there are two sub-cases:
   a. The overall read or write size overlaps with the data being copied, but the requested starting offset is located at an offset prior to the data being copied. In this sub-case, orchestrator 300 can perform the read/write operations until it hits the offset where the data copy is ongoing and returns short. In Linux, read/write syscalls are allowed to return “short” (read or write less data than requested). The caller is responsible for trying to read/write again to finish the operation.
   b. Read or write starts at or after the offset being currently copied. In this sub-case, orchestrator 300 can hold the operation until the current write syscall for the copy progresses enough that it can serve some of the requested read or write operations and return short. Another way to frame this is that the hold procedure is waiting for the operation to fall back into sub-case (2)(a) above.
3. A read or write is received to a section of a file not copied yet. In this case, orchestrator 300 can serve the read/write from the origin file.

With this scheme, mode switchovers (i.e., a switch from enabling to disabling UDE mode or vice versa) are transparent to the storage mount point interface. File descriptors opened prior to a mode switch or during a switch fall under two cases:
1. The file descriptor points to a file that won't move. For example, if the file “boot-config” is opened prior to encryption enablement, that would already have been opened off of the unencrypted location in passthrough mode. When encryption is enabled or disabled, or unrelated data is moved, this kind of file descriptor can be left alone.
2. The file descriptor points to a file that needs to move. The scheme above handles this case by guaranteeing continuous data consistency to the storage mount point interface while the data is being moved from the unencrypted area to the encrypted area or vice-versa. When the move is done, the file descriptor will have transparently switched to being served from the destination file.

### 3.5 Turning Off Encryption

In various embodiments, disabling UDE mode can be performed in a manner that either keeps or does not keep the existing encrypted user data in user data directory 306. In the latter case, orchestrator 300 can switch over to operating in the passthrough mode mentioned earlier, the user-data directory can be erased, and the encryption key held in the TPM can be overwritten (e.g., with zeroes). Zeroing out the key can help with identifying if a key is there or the index is cleared. Network device 200 can then automatically (or offer an option to) reboot into ZTP mode, which makes it easy to re-provision the device.

In the former case, the encrypted user data should be moved from the encrypted area to the unencrypted area, which implicates the challenges mentioned in section 3.4 above. Once all of the data is moved, orchestrator 300 can switch over to passthrough mode, the user-data directory can be unmounted and removed, and the encryption key in the TPM can be zero'ed out.

### 3.6 User-Configurable Exception List

In certain embodiments, UDE framework 202 can support a user-configurable exception list, which means that device users can mark certain paths and/or files that are typically considered user data (and thus encrypted) to instead be considered OS/boot data (and thus remain unencrypted). The paths can be specified as simple paths or using regular expressions.

### 3.7 Secure Erase and Factory Reset

Secure erase and factory reset are two options to clear the existing filesystem partition(s) on persistent storage 114 and to restore network device 200 to factory-default settings (secure erase also guarantees that all of the data on persistent storage 114 is completely wiped). With the implementation of UDE framework 202, these options can be augmented to also clear the NVRAM of the TPM, thereby deleting the encryption metadata stored there for performing user data encryption.

The above description illustrates various embodiments of the present disclosure along with examples of how aspects of these embodiments may be implemented. The above examples and embodiments should not be deemed to be the only embodiments and are presented to illustrate the flexibility and advantages of the present disclosure as defined by the following claims. For example, although certain embodiments have been described with respect to particular workflows and steps, it should be apparent to those skilled in the art that the scope of the present disclosure is not strictly limited to the described workflows and steps. Steps described as sequential may be executed in parallel, order of steps may be varied, and steps may be modified, combined, added, or omitted. As another example, although certain embodiments may have been described using a particular combination of hardware and software, it should be recognized that other combinations of hardware and software are possible, and that specific operations described as being implemented in hardware can also be implemented in software and vice versa.

The specification and drawings are, accordingly, to be regarded in an illustrative rather than restrictive sense. Other arrangements, embodiments, implementations, and equivalents will be evident to those skilled in the art and may be employed without departing from the spirit and scope of the present disclosure as set forth in the following claims.

1. A method performed by a network device for operating in a user data encryption (UDE) mode, the method comprising:
receiving a filesystem access directed to a persistent storage of the network device;
determining whether the filesystem access pertains to creation of a filesystem object on the persistent storage;
in response to determining that the filesystem access pertains to creation of a filesystem object, determining whether the filesystem object is user data;
in response to determining that the filesystem object is user data, creating the filesystem object in encrypted form in an encrypted area of the persistent storage; and
in response to determining that the filesystem object is not user data, creating the filesystem object in unencrypted form in an unencrypted area of the persistent storage.

2. The method of claim 1 wherein the filesystem access originated from a user of the network device and wherein the creating of the filesystem object in encrypted form is transparent to the user.

3. The method of claim 1 wherein determining whether the filesystem object is user data comprises:
checking whether the filesystem object is included in a predefined list.

4. The method of claim 3 wherein the predefined list comprises filesystem objects representative of operating system (OS) and boot data used by the network device, and wherein the filesystem object is determined to be user data if the filesystem object is not present in the predefined list.

5. The method of claim 1 wherein the method is performed by a filesystem orchestration layer that is mounted to a storage mount point associated with the persistent storage.

6. The method of claim 5 further comprising, in response to determining that the filesystem access does not pertain to creation of a filesystem object:
passing, by the filesystem orchestration layer, the filesystem access to a filesystem merger layer for handling, the filesystem merger layer being configured to provide a merged view of the encrypted area and the unencrypted area.

7. The method of claim 5 wherein when the UDE mode is disabled, the filesystem orchestration layer transitions to operating in a passthrough mode that comprises passing all received filesystem accesses through to a partition mount point associated with the unencrypted area.

8. The method of claim 5 wherein when the UDE mode is disabled, the filesystem orchestration layer is unmounted from the storage mount point and the storage mount point is bound to a partition mount point associated with the unencrypted area.

9. The method of claim 5 wherein when the UDE mode is enabled, the filesystem orchestration layer moves all filesystem objects considered to be user data from the unencrypted area to the encrypted area.

10. A network device comprising:
a processor;
a persistent storage; and
a memory having stored thereon program code for operating in a user data encryption (UDE) mode, wherein upon being executed the program code causes the processor to:
receiving a filesystem access directed to the persistent storage;
determining whether the filesystem access pertains to creation of a filesystem object on the persistent storage;
in response to determining that the filesystem access pertains to creation of a filesystem object, determining whether the filesystem object is user data;
in response to determining that the filesystem object is user data, creating the filesystem object in encrypted form in an encrypted area of the persistent storage; and
in response to determining that the filesystem object is not user data, creating the filesystem object in unencrypted form in an unencrypted area of the persistent storage.

11. The network device of claim 10 wherein the filesystem access originated from a user of the network device and wherein the creating of the filesystem object in encrypted form is transparent to the user.

12. The network device of claim 10 wherein the program code that causes the processor to determine whether the filesystem object is user data comprises program code that causes the processor to:
check whether the filesystem object is included in a predefined list.

13. The network device of claim 12 wherein the predefined list comprises filesystem objects representative of operating system (OS) and boot data used by the network device, and wherein the filesystem object is determined to be user data if the filesystem object is not present in the predefined list.

14. The network device of claim 10 wherein the program code is executed by a filesystem orchestration layer that is mounted to a storage mount point associated with the persistent storage.

15. The network device of claim 14 wherein the program code further causes the processor to, in response to determining that the filesystem access does not pertain to creation of a filesystem object:
pass, via the filesystem orchestration layer, the filesystem access to a filesystem merger layer for handling, the filesystem merger layer being configured to provide a merged view of the encrypted area and the unencrypted area.

16. The network device of claim 14 wherein when the UDE mode is disabled, the filesystem orchestration layer transitions to operating in a passthrough mode that comprises passing all received filesystem accesses through to a partition mount point associated with the unencrypted area.

17. The network device of claim 14 wherein when the UDE mode is disabled, the filesystem orchestration layer is unmounted from the storage mount point and the storage mount point is bound to a partition mount point associated with the unencrypted area.

18. The network device of claim 14 wherein when the UDE mode is enabled, the filesystem orchestration layer moves all filesystem objects considered to be user data from the unencrypted area to the encrypted area.

19. A method performed by a network device, the method comprising:
receiving a filesystem access directed to a persistent storage of the network device;
determining that the filesystem access pertains to creation of user data on the persistent storage; and
in response to the determining, creating the user data in encrypted form in an encrypted area of the persistent storage.

20. The method of claim 19 wherein the creating of the user data in encrypted form is transparent to users of the network device.
